(19) United States
(12) Patent Application Publication
(10) Pub. No.: US 2008/0140627 A1
(43) Pub. Date: Jun. 12, 2008

(54) METHOD AND APPARATUS FOR AGGREGATING DATABASE RUNTIME INFORMATION AND ANALYZING APPLICATION PERFORMANCE

(75) Inventors: Patrick Dooling BOSSMAN, Alexandria, VA (US); You-Chin FUH, San Jose, CA (US); Kun Peng REN, Beijing (CN); Chan-Hua LIU, San Jose, CA (US); Bing Jiang SUN, Beijing (CN); Fang XING, Beijing (CN)

Correspondence Address: SAWYER LAW GROUP LLP, P.O. BOX 51418, PALO ALTO, CA, 94303, US

(73) Assignee: INTERNATIONAL BUSINESS MACHINES CORPORATION, Armonk, NY (US)

(21) Appl. No.: 11/849,181

(22) Filed: Aug. 31, 2007

(30) Foreign Application Priority Data
Dec. 8, 2006 (CN) 200610164589.4

(51) Int. Cl. G06F 17/30

(52) U.S. Cl. 707/3; 707/E17.014

(57) ABSTRACT

The present invention provides a method and an apparatus for aggregating database runtime information and analyzing application performance. According to one aspect of the present invention, there is provided a method for aggregating database runtime information, comprising: aggregating said database runtime information based on queries; and aggregating, based on objects, said database runtime information that is aggregated based on queries.

### TECHNICAL FIELD

The present invention relates to technology of database optimization, more particularly to a method and an apparatus for aggregating database runtime information and analyzing application performance.

### TECHNICAL BACKGROUND

With the growing demands of database application, the number and the complexity of the query in the application increase obviously, and it is a great challenge for the database administrators and the application developers to do database and application performance optimization, database design improvement and database maintenance. Generally, the database administrators need to adjust the database application performance based on the statistic information and the resource utilization, improve the database design, for example, index etc., based on the query actually running in the database, and determine when to perform the database maintenance while minimizing the impact to the application performance. However, it is quit difficult for the database administrators to do this work by directly using the thousands upon thousands query information running in the database system.

One main reason for the above-mentioned difficulty is due to insufficient relevant query information. In order to perform the application performance adjustment, the database administrators and the application developers need to record some query information, for example, query execution frequency, related table, column, column group and index etc. This information is in favor of the database design improvement. In order to determine when to perform the database maintenance, the database administrators need to obtain more detailed information so that they know when the optimal time to perform the database maintenance is. However, it is all a huge overload for the storage space and the system performance to simply collect and save this information. As a result, the database administrators usually can only collect a small amount of query information, and this can not obtain sufficient information.

Some current database solutions are enumerated as follows, for example, Oracle, IBM DB2 and Microsoft SQL Server.

### Oracle

Oracle can aggregate the query runtime information, and save the access path optionally. However, it has not historical information, and it can not provide detailed information for further analysis and when the optimal time to perform the database maintenance needs to be determined.

### IBM DB2

Cogito has two products EZ-Tracer and EZ-SOL Warehouse on DB2. They can monitor the query, capture the query instance, aggregate the runtime information, collect the access path, and load this information into the warehouse for further analysis. However, like Oracle, Cogito has not sufficient historical information to determine the optimal time of the database maintenance.

### Microsoft SQL Server

Some tracing tools of Microsoft SQL Server can monitor and capture query activities of the server, however, the obtained query information is very limited, which has not the aggregate query runtime information and the access path information. Further, not all queries in the application can be monitored.

### SUMMARY OF THE INVENTION

In order to solve the above-mentioned problems in the prior technology, the present invention provides a method and an apparatus for aggregating database runtime information and analyzing application performance.

According to an aspect of the present invention, there is provided a method for aggregating database runtime information, comprising: aggregating the above-mentioned database runtime information based on queries; and aggregating, based on objects, the above-mentioned database runtime information that is aggregated based on queries.

According to another aspect of the present invention, there is provided a method for analyzing application performance, comprising: analyzing application performance based on the information obtained by using the above-mentioned method for aggregating database runtime information.

According to another aspect of the present invention, there is provided an apparatus for aggregating database runtime information, comprising: a query aggregating unit configured to aggregate the above-mentioned database runtime information based on queries; and an object aggregating unit configured to aggregate, based on objects, the above-mentioned database runtime information that is aggregated based on queries.

According to another aspect of the present invention, there is provided an apparatus for analyzing application performance, comprising an analyzing unit configured to analyze application performance based on the information obtained by using the above-mentioned apparatus for aggregating database runtime information.

### BRIEF DESCRIPTION OF THE DRAWINGS

It is believed that through the following detailed description of the embodiments of the present invention, taken in conjunction with the drawings, the above-mentioned features, advantages, and objectives will be better understood.

FIG. 1 is a flowchart showing a method for aggregating database runtime information according to an embodiment of the present invention;

FIG. 2 is a flowchart showing a method for analyzing application performance according to another embodiment of the present invention;

FIG. 3 is a block diagram showing an apparatus for aggregating database runtime information according to another embodiment of the present invention; and

FIG. 4 is a block diagram showing an apparatus for analyzing application performance according to another embodiment of the present invention.

### DETAILED DESCRIPTION OF THE INVENTION

Next, a detailed description of each embodiment of the present invention will be given in conjunction with the accompany drawings.

### Method for Aggregating Database Runtime Information

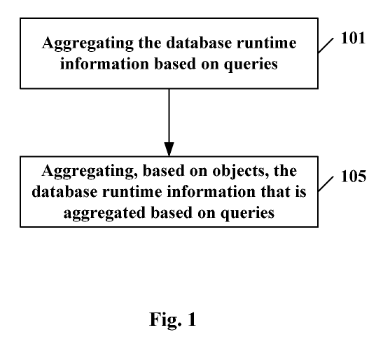

FIG. 1 is a flowchart showing a method for aggregating database runtime information according to an embodiment of the present invention. As shown in FIG. 1, first at Step 101, the above-mentioned database runtime information is aggregated based on queries. Specifically, the database used in this embodiment can be any database as known to one skilled in the art, for example, Oracle, IBM DB2, Microsoft SQL Server, and also can be any database developed in the future. The present invention has no special limitation to this. Further, the basic elements of the database comprise, for example, table and index etc.

In this embodiment, the database runtime information indicates the information related to the running process of the query, for example, the query executed on the database, and the corresponding runtime information. It should be recognized, in this embodiment, the “query” indicates a query in a broad sense, for example, all database manipulations processed by using Data Manipulation Language (DML).

Specifically, at Step 101, first a query statement and meta information of each query instance is extracted from the database. In this embodiment, a combination of the query statement and meta information is taken as a query instance. A detailed description of the query statement and meta information will be given as follows.

In this embodiment, the query statement comprises a basic query statement in Structured Query Language (SQL), specifically, comprises a basic query statement in Data Manipulation Language (DML), for example, inserting data, updating data, deleting data, selecting data in a database and so on, and the present invention has no special limitation to this. In this embodiment, the meta information indicates meta information related to explanation, execution, optimization, compiler of the query and so on, for example, schema, security option and optimization option in a general database. Specifically, the schema is used to specify a database object related to executing one query statement; the security option is used to limit the access of executing one query statement; and the optimization option is used to assist the selection of executing path. For example, the schema indicates the same query statements corresponding to the different queries, thus the result obtained is also different due to the different users.

Specifically, for example, in IBM DB2, the meta information can also indicate binding option according to an embodiment of the present invention, which comprises execution option and compiler option. Binding option has been described in detail in IBM DB2 Universal Database for z/OS, Version 8. Command Reference Chapter 15, which is incorporated herein by reference and the description of which is omitted.

At Step 101, after extracting the query statement and meta information of each query instance from the database, the above-mentioned database runtime information is aggregated at a minimum time unit based on each query, i.e. combination of the query statement and meta information. In this embodiment, the minimum time unit can be set based on the requirement, for example, one hour, one day and so on, and the present invention has no special limitation to this.

Specifically, at this step, for each query, the runtime information of the query instance corresponding to the query is calculated during each minimum time unit. In this embodiment, the runtime information comprises but not limits to: CPU time, elapse time, execution counts, number of synchronous I/O, number of getpage operations, number of synchronous buffer read operations performed, number of synchronous buffer write operations performed, number of rows processed, number of sorts performed, number of index scans performed, number of tablespace scans performed, number of parallel groups created, wait time for lock and latch requests, wait time for global locks, wait time for read activity done by other threads, wait time for write activity done by other threads and so on, and the present invention has no special limitation to this.

In this embodiment, the elapse time indicates the time that the database engine costs to complete the query instance corresponding to the query. If the query instance corresponding to the query comprises a plurality of query instances during the minimum time unit, the total time that the plurality of query instances cost will be taken as the elapse time of the query instance corresponding to the query herein.

Further, an access path of the query instance corresponding to the query is extracted during each minimum time unit. In this embodiment, the access path indicates, when one query relates to a plurality of objects, the order of selecting a plurality of database objects and the access methods for different objects, for example, for one query statement:

SELECT * FROM TABLE1, TABLE2, TABLE3 WHERE AGE=12

If TABLE2 is selected first, TABLE1 is selected next, and TABLE3 is selected at last, the access order of the query instance corresponding to the query is [TABLE2, TABLE1, TABLE3]. It should be understood that, the access path specialized herein is just for the purpose of description, and the access path used in this embodiment can be any access path as known to one skilled in the art.

Optionally, in this embodiment, the plurality of queries which have same semantic meaning of the query statement and meta information can be consolidated. In this embodiment, the queries which have same semantic meaning indicate the queries which have merely different letters or variable parameters. For example, for the following two query statements:

SELECT * FROM TABLE1, TABLE2, TABLE3 WHERE AGE=12

SELECT * FROM TABLE1, TABLE2, TABLE3 WHERE AGE=13

The two are merely different in writing mode, if the corresponding queries have same meta information, the results and the processes of executing the two queries practically have not any differences, and thereby, the two queries can be consolidated to one query.

Further, optionally, in this embodiment, the access paths repeated under the same query during the same time unit can be deleted. As known to all, during a certain time, the access path may not change, and thereby, the access paths repeated under the same query can be deleted.

At last, at Step 105, the above-mentioned database runtime information that is aggregated based on queries at Step 101 is aggregated based on objects. Specifically, first, all objects included in the above-mentioned access path are extracted, and next, the above-mentioned database runtime information that is aggregated based on queries is aggregated based on each object extracted at the minimum time unit. Herein, the minimum time unit is same as the above-mentioned minimum time unit, and can be set based on the requirement, for example, one hour, one day and so on.

In this embodiment, the object extracted from the above-mentioned access path comprises any object as known to one skilled in the art, for example, table, column, column group and index etc., and the present invention has no special limitation to this.

Specifically, at Step 105, for each object, the runtime information of the query instance containing the object in the access path is calculated during each minimum time unit, for example, comprising but not limiting to CPU time, elapse time, execution counts, number of synchronous I/O, number of getpage operations, number of synchronous buffer read operations performed, number of synchronous buffer write operations performed, number of rows processed, number of sorts performed, number of index scans performed, number of tablespace scans performed, number of parallel groups created, wait time for lock and latch requests, wait time for global locks, wait time for read activity done by other threads, wait time for write activity done by other threads and so on, and the present invention has no special limitation to this.

In this embodiment, the elapse time indicates the time that the database engine costs to complete the query instance containing the object in the access path. If the query instances of the object included in the access path comprises a plurality of query instances, the total time that the plurality of query instances cost will be taken as the elapse time of the query instance containing the object in the access path.

By using the method for aggregating database runtime information in this embodiment, sufficient and useful information can be provided for application performance adjustment, database design improvement and database maintenance. This information comprises the information related to the query and the object, and thereby, convenience can be provided for the database administrators to do the above-mentioned work.

Further, by using the method for aggregating database runtime information in this embodiment, the database runtime information can be effectively aggregated in order to reduce the space overload and improve the analysis efficiency. Specifically, the original data are aggregated to the useful information for analysis, the similar data are consolidated, the repeated data are deleted, thereby, the space overload is reduced and the time cost to analyze is reduced synchronously.

### Method for Analyzing Application Performance

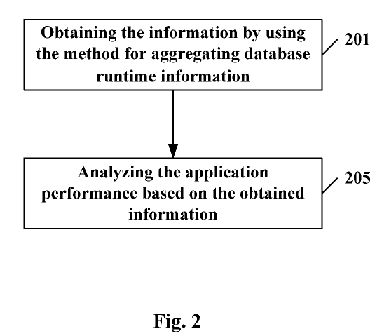

Under the same inventive conception, FIG. 2 is a flowchart showing a method for analyzing application performance according to another embodiment of the present invention. Next, the present embodiment will be described in conjunction with FIG. 2. For those same parts as the above embodiments, the description of which will be appropriately omitted.

As shown in FIG. 2, first at Step 201, the database runtime information is aggregated by using the method for aggregating database runtime information, and the information aggregated is obtained. Specifically, the database used in this embodiment can be any database as known to one skilled in the art, for example, Oracle, IBM DB2, Microsoft SOL Server, also can be any database developed in the future, and the present invention has no special limitation to this. Further, in this embodiment, the database runtime information indicates any information related in the database running process, for example, various manipulations performed on the database, and the present invention has no special limitation to this. Further, in this embodiment, the method for aggregating database runtime information can be the above-mentioned method according to the embodiment of FIG. 1, and also can be any method as known to one skilled in the art.

At last, at Step 205, the application performance is analyzed based on the information obtained by using the method for aggregating database runtime information at Step 201. Specifically, the analysis for the application performance comprises extracting a histogram of the database query and the database object changing with time, providing a systemic and effective data support to the database system optimization, and performing any database optimization as known to one skilled in the art. The present invention has no special limitation to this.

By using the method for analyzing application performance in this embodiment, sufficient and useful information can be provided for application performance adjustment, database design improvement and database maintenance. This information comprises the information related to the query and the object, and thereby, convenience can be provided for the database administrators to do the above-mentioned work.

Further, by using the method for analyzing application performance in this embodiment, the database runtime information can be effectively aggregated in order to reduce the space overload and improve the analysis efficiency. Specifically, the original data are aggregated to the useful information for analysis, the similar data are consolidated, the repeated data are deleted, thereby, the space overload is reduced and the time cost to analyze is reduced synchronously.

### Apparatus for Aggregating Database Runtime Information

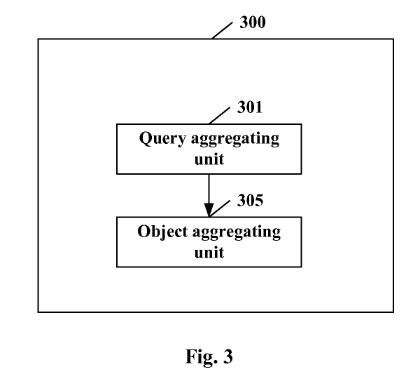

Under the same inventive conception, FIG. 3 is a block diagram showing an apparatus for aggregating database runtime information according to another embodiment of the present invention. Next, the present embodiment will be described in conjunction with FIG. 3. For those same parts as the above embodiments, the description of which will be appropriately omitted.

As shown in FIG. 3, an apparatus 300 for aggregating database runtime information in this embodiment comprises: a query aggregating unit 301 configured to aggregate the above-mentioned database runtime information based on queries; and an object aggregating unit 305 configured to aggregate, based on objects, the above-mentioned database runtime information that is aggregated based on queries.

Specifically, the database used in this embodiment can be any database as known to one skilled in the art, for example, Oracle, IBM DB2, Microsoft SQL Server, and also can be any database developed in the future. The present invention has no special limitation to this. Further, the basic elements of the database comprise, for example, table and index etc.

In this embodiment, the database runtime information indicates the information related to the running process of the database, for example, various manipulations performed on the database, and the information of the database executing each query instance. It should be recognized, in this embodiment, the “query” indicates a query in a broad sense, for example, all database manipulations processed by using Data Manipulation Language (DML).

Specifically, the query aggregating unit 301 comprises an extracting unit configured to extract the query statement and meta information of each query instance from the above-mentioned database runtime information. In this embodiment, the combination of the query statement and meta information is taken as a query. A detailed description of the query statement and meta information will be given as follows.

In this embodiment, the query statement comprises a basic query statement in Structured Query Language (SQL), specifically, comprises a basic query statement in Data Manipulation Language (DML), for example, inserting data, updating data, deleting data, selecting data in a database and so on, and the present invention has no special limitation to this. In this embodiment, the meta information indicates meta information related to explanation, execution, optimization, compiler of the query and so on, for example, schema, security option and optimization option in a general database. Specifically, the schema is used to specify a database object related to executing one query statement; the security option is used to limit the access of executing one query statement; and the optimization option is used to assist the selection of executing path. For example, the schema indicates the same query statements corresponding to the different queries, thus the result obtained is also different due to the different users.

Specifically, for example, in IBM DB2, the meta information can also indicate binding option according to an embodiment of the present invention, which comprises execution option and compiler option. Binding option has been described in detail in IBM DB2 Universal Database for z/OS, Version 8, Command Reference Chapter 15, which is incorporated herein by reference and the description of which is omitted.

In this embodiment, after the extracting unit of the query aggregating unit 301 extracts the query statement and meta information of each query instance from the above-mentioned database runtime information, the query aggregating unit 301 aggregates the above-mentioned database runtime information at the minimum time unit based on each query, i.e. combination of the query statement and meta information. In this embodiment, the minimum time unit can be set based on the requirement, for example, one hour, one day and so on, and the present invention has no special limitation to this.

Specifically, the query aggregating unit 301 further comprises a time calculating unit configured to calculate, for each query, the runtime information of the query instance corresponding to the query during each minimum time unit. In this embodiment, the runtime information comprises but not limits to: CPU time, elapse time, execution counts, number of synchronous I/O, number of getpage operations, number of synchronous buffer read operations performed, number of synchronous buffer write operations performed, number of rows processed, number of sorts performed, number of index scans performed, number of tablespace scans performed, number of parallel groups created, wait time for lock and latch requests, wait time for global locks, wait time for read activity done by other threads, wait time for write activity done by other threads and so on, and the present invention has no special limitation to this.

In this embodiment, the elapse time indicates the time that the database engine costs to complete the query instance corresponding to the query. If the query instance corresponding to the query comprises a plurality of query instances during the minimum time unit, the total time that the plurality of query instances cost will be taken as the elapse time of the query instance corresponding to the query herein.

Further, the query aggregating unit 301 further comprises a path extracting unit configured to extract the access path of the query instance corresponding to the query during each minimum time unit. In this embodiment, the access path indicates, when one query relates to a plurality of objects, the order of selecting a plurality of database objects, for example, for one query statement:

SELECT * FROM TABLE1, TABLE2, TABLE3 WHERE AGE=12

If TABLE2 is selected first, TABLE1 is selected next, and TABLE3 is selected at last, the access order of the query instance corresponding to the query is [TABLE2, TABLE1, TABLE3]. It should be understood that, the access path specialized herein is just for the purpose of description, and the access path used in this embodiment can be any access path as known to one skilled in the art.

Optionally, in this embodiment, the query aggregating unit 301 further comprises a consolidating unit configured to consolidate the plurality of queries which have same semantic meaning of the query statement and meta information. In this embodiment, the queries which have same semantic meaning indicate the queries which have merely different letters or variable parameters. For example, for the following two query statements:

SELECT * FROM TABLE1, TABLE2, TABLE3 WHERE AGE=12

SELECT * FROM TABLE1, TABLE2, TABLE3 WHERE AGE=13

The two are merely different in writing mode, if the corresponding queries have same meta information, the results and the processes of executing the two queries practically have not any differences, and thereby, the two queries can be consolidated to one query.

Further, optionally, in this embodiment, the query aggregating unit 301 further comprises a deleting unit configured to delete the access paths repeated under the same query during the same time unit. As known to all, during a certain time, the access path may not change, and thereby, the access paths repeated under the same query can be deleted.

In this embodiment, the object aggregating unit 305 aggregates, based on objects, the above-mentioned database runtime information that is aggregated based on queries according to the query aggregating unit 301. Specifically, the object aggregating unit 305 comprises the extracting unit configured to extract all objects included in the above-mentioned access path, and next, the object aggregating unit 305 aggregates, based on each object extracted, the above-mentioned database runtime information that is aggregated based on queries at the minimum time unit. Herein, the minimum time unit is same as the above-mentioned minimum time unit, and can be set based on the requirement, for example, one hour, one day and so on.

In this embodiment, the object extracted from the above-mentioned access path comprises any object as known to one skilled in the art, for example, table, column, column group and index etc., and the present invention has no special limitation to this.

Specifically, the object aggregating unit 305 further comprises the time calculating unit configured to calculate, for each object, the runtime information of the query instance containing the object in the access path during each minimum time unit, for example, comprising but not limiting to CPU time, elapse time, execution counts, number of synchronous I/O, number of getpage operations, number of synchronous buffer read operations performed, number of synchronous buffer write operations performed, number of rows processed, number of sorts performed, number of index scans performed, number of tablespace scans performed, number of parallel groups created, wait time for lock and latch requests, wait time for global locks, wait time for read activity done by other threads, wait time for write activity done by other threads and so on, and the present invention has no special limitation to this.

In this embodiment, the elapse time indicates the time that the database engine costs to complete the query instance containing the object in the access path. If the query instances of the object included in the access path comprises a plurality of query instances, the total time that the plurality of query instances cost will be taken as the elapse time of the query instance containing the object in the access path.

By using the apparatus 300 for aggregating database runtime information in this embodiment, sufficient and useful information can be provided for application performance adjustment, database design improvement and database maintenance. This information comprises the information related to the query and the object, and thereby, convenience can be provided for the database administrators to do the above-mentioned work.

Further, by using the apparatus 300 for aggregating database runtime information in this embodiment, the database runtime information can be effectively aggregated in order to reduce the space overload and improve the analysis efficiency. Specifically, the original data are aggregated to the useful information for analysis, the similar data are consolidated, the repeated data are deleted, thereby, the space overload is reduced and the time cost to analyze is reduced synchronously.

### Apparatus for Analyzing Application Performance

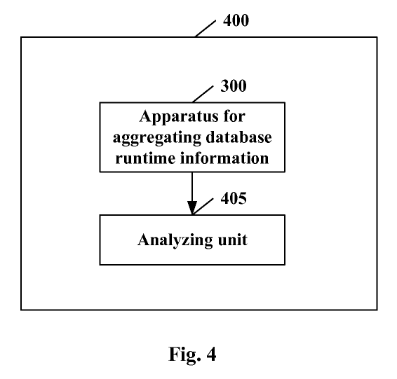

Under the same inventive conception, FIG. 4 is a block diagram showing an apparatus for analyzing application performance according to another embodiment of the present invention. Next, the present embodiment will be described in conjunction with FIG. 4. For those same parts as the above embodiments, the description of which will be appropriately omitted.

As shown in FIG. 4, an apparatus 400 for analyzing application performance in this embodiment comprises the apparatus for aggregating database runtime information configured to obtain the aggregated information; and an analyzing unit 405 configured to analyze the application performance.

Specifically, the database used in this embodiment can be any database as known to one skilled in the art, for example, Oracle, IBM DB2, Microsoft SQL Server, also can be any database developed in the future, and the present invention has no special limitation to this. Further, in this embodiment, the database runtime information indicates any information related in the database running process, for example, various manipulations performed on the database, and the present invention has no special limitation to this. Further, in this embodiment, the apparatus for aggregating database runtime information can be the above-mentioned apparatus 300 for aggregating database runtime information according to the embodiment of FIG. 3, and also can be any apparatus as known to one skilled in the art.

In this embodiment, the analyzing unit 405 analyzes the application performance based on the information obtained by using the apparatus for aggregating database runtime information. Specifically, the analysis for the application performance comprises extracting a histogram of the database query and the database object changing with time, providing a systemic and effective data support to the database system optimization, and performing any database optimization as known to one skilled in the art. The present invention has no special limitation to this.

By using the apparatus 400 for analyzing application performance in this embodiment, sufficient and useful information can be provided for application performance adjustment, database design improvement and database maintenance. This information comprises the information related to the query and the object, and thereby, convenience can be provided for the database administrators to do the above-mentioned work.

Further, by using the apparatus 400 for analyzing application performance in this embodiment, the database runtime information can be effectively aggregated in order to reduce the space overload and improve the analysis efficiency. Specifically, the original data are aggregated to the useful information for analysis, the similar data are consolidated, the repeated data are deleted, thereby, the space overload is reduced and the time cost to analyze is reduced synchronously.

Though a method for aggregating database runtime information, a method for analyzing application performance, an apparatus for aggregating database runtime information, and an apparatus for analyzing application performance have been described in details with some exemplary embodiments, these above embodiments are not exhaustive. Those skilled in the art can make various variations and modifications within the spirit and the scope of the present invention. Therefore, the present invention is not limited to these embodiments; rather, the scope of the present invention is only defined by the appended claims.

1. A method for aggregating database runtime information, comprising:
aggregating said database runtime information based on queries; and
aggregating, based on objects, said database runtime information that is aggregated based on queries.

2. The method according to claim 1, wherein, the step of aggregating said database runtime information based on queries comprises:
extracting a query statement and meta information of each query instance from said database runtime information; and
aggregating said database runtime information at a minimum time unit based on each combination of said query statement and meta information.

3. The method according to claim 2, wherein, the step of aggregating said database runtime information at a minimum time unit based on each combination of said query statement and meta information comprises:
calculating runtime information of the query instance corresponding to said combination of said query statement and meta information during each said minimum time unit; and
extracting an access path of the query instance corresponding to said combination of said query statement and meta information during each said minimum time unit.

4. The method according to claim 3, wherein, said runtime information comprises one or more of CPU time, elapse time, execution counts, number of synchronous I/O, number of getpage operations, number of synchronous buffer read operations performed, number of synchronous buffer write operations performed, number of rows processed, number of sorts performed, number of index scans performed, number of tablespace scans performed, number of parallel groups created, wait time for lock and latch requests, wait time for global locks, wait time for read activity done by other threads and wait time for write activity done by other threads.

5. The method according to claim 4, wherein, the step of aggregating, based on objects, said database runtime information that is aggregated based on queries comprises:
extracting all objects included in said access path; and
aggregating, based on each said object, said database runtime information that is aggregated based on queries at a minimum time unit.

6. The method according to claim 5, wherein, the step of aggregating, based on each said object, said database runtime information that is aggregated based on queries at a minimum time unit comprises:
calculating runtime information of a query instance containing said object in the access path during each said minimum time unit.

7. The method according to claim 6, wherein, said runtime information comprises one or more of CPU time, elapse time, execution counts, number of synchronous I/O, number of getpage operations, number of synchronous buffer read operations performed, number of synchronous buffer write operations performed, number of rows processed, number of sorts performed, number of index scans performed, number of tablespace scans performed, number of parallel groups created, wait time for lock and latch requests, wait time for global locks, wait time for read activity done by other threads and wait time for write activity done by other threads.

8. The method according to claim 2, wherein, the step of aggregating said database runtime information based on queries further comprises:
consolidating queries which have same semantic meaning of said query statement and meta information.

9. The method according to claim 8, wherein, the step of aggregating said database runtime information based on queries further comprises:
deleting access paths repeated under the same query during the same time unit.

10. The method according to claim 2, wherein, said meta information comprises: one or more of schema, security option, optimization option, binding option, execution option and compiler option.

11. An apparatus for aggregating database runtime information, comprising:
a query aggregating unit configured to aggregate said database runtime information based on queries; and
an object aggregating unit configured to aggregate, based on objects, said database runtime information that is aggregated based on queries.

12. The apparatus according to claim 11, wherein, said query aggregating unit comprises:
an extracting unit configured to extract a query statement and meta information of each query instance from said database runtime information; and
wherein, said query aggregating unit configured to aggregate said database runtime information at a minimum time unit based on each combination of said query statement and meta information.

13. The apparatus according to claim 12, wherein, said query aggregating unit comprises:
a time calculating unit configured to calculate runtime information of the query instance corresponding to said combination of said query statement and meta information during each said minimum time unit; and
an access path extracting unit configured to extract an access path of the query instance corresponding to said combination of said query statement and meta information during each said minimum time unit.

14. The apparatus according to claim 13, wherein, said runtime information comprises one or more of CPU time, elapse time, execution counts, number of synchronous I/O, number of getpage operations, number of synchronous buffer read operations performed, number of synchronous buffer write operations performed, number of rows processed, number of sorts performed, number of index scans performed, number of tablespace scans performed, number of parallel groups created, wait time for lock and latch requests, wait time for global locks, wait time for read activity done by other threads and wait time for write activity done by other threads.

15. The apparatus according to claim 14, wherein, said object aggregating unit comprises:
an extracting unit configured to extract all objects included in said access path; and
wherein, said object aggregating unit configured to aggregate, based on each said object, said database runtime information that is aggregated based on queries at a minimum time unit.

16. The apparatus according to claim 15, wherein, said object aggregating unit comprises:
a time calculating unit configured to calculate runtime information of a query instance containing said object in the access path during each said minimum time unit.

17. The apparatus according to claim 16, wherein, said runtime information comprises one or more of CPU time, elapse time, execution counts, number of synchronous I/O, number of getpage operations, number of synchronous buffer read operations performed, number of synchronous buffer write operations performed, number of rows processed, number of sorts performed, number of index scans performed, number of tablespace scans performed, number of parallel groups created, wait time for lock and latch requests, wait time for global locks, wait time for read activity done by other threads and wait time for write activity done by other threads.

18. The apparatus according to claim 12, wherein, said query aggregating unit further comprises:
a consolidating unit configured to consolidate queries which have same semantic meaning of said query statement and meta information.

19. The apparatus according to claim 18, wherein said query aggregating unit further comprises:
a deleting unit configured to delete access paths repeated under the same query during the same time unit.

20. The apparatus according to claim 12, wherein, said meta information comprises: one or more of schema, security option, optimization option, binding option, execution option and compiler option.
